(19) United States
(12) Patent Application Publication
(10) Pub. No.: US 2021/0080780 A1
(43) Pub. Date: Mar. 18, 2021

(54) LIQUID CRYSTAL DISPLAY PANEL

(71) Applicant: TCL China Star Optoelectronics Technology Co, Ltd, Shenzhen, Guangdong (CN)

(72) Inventor: Zehu HU, Shenzhen, Guangdong (CN)

(21) Appl. No.: 16/618,814

(22) PCT Filed: Nov. 13, 2019
(86) PCT No.: PCT/CN2019/117929

§ 371 Date: Dec. 3, 2019

(30) Foreign Application Priority Data
Sep. 12, 2019 (CN) 201910863793.2

(51) Int. Cl. G02F 1/1335

(52) U.S. Cl. CPC G02F 1/133516; G02F 1/133512

(57) ABSTRACT

A liquid crystal display panel includes a first underlay substrate and a photoresist layer disposed on the first underlay substrate. The first underlay substrate includes a first region and a second region. A top surface of the first region is lower than a top surface of the second region. The photoresist layer includes photoresists disposed on the first region or the second region, and surfaces of the photoresists are flush with one another. By designing a step difference of different regions of the underlay substrate, surfaces of the color resists later manufactured are flush with one another to avoid influence of the color resists with step differences to rotation of liquid crystal.

### FIELD OF INVENTION

The present invention relates to a field of display technologies, especially to a liquid crystal display panel.

### BACKGROUND OF INVENTION

In a liquid crystal display panel, when a color filter is manufactured, because a black matrix has a certain height, in a later process for manufacturing colored color resists, fluidities of color resists in different regions are different such that horn-like step differences or bowl-like color resists are formed in an overlapping region of the color resists. Thus, thicknesses of the color resists are different, uneven display occurs when light of a backlight passes through the color filter, and display quality are affected.

Furthermore, when a color filter on array (COA, a color filter layer integrated on an array substrate) type array substrate is manufactured, because specifications of products for clients are different, multiple materials are required during production, frequent changes in material of the color resist result in a low use rate of color resists and further result in a poor production rate. At present, although adjusting a film thickness for different each color resist can fulfill standards of different colors and lower types of color resists required for changes, however due to a height difference among the color resists, an excessive height difference will seriously affect rotation of liquid crystal and further influence display quality.

As described above, both the color filter and the COA type array substrate has the issue of a height difference among the colored color resists causes poor display.

### SUMMARY OF INVENTION

The present invention provides a liquid crystal display panel, to solve a technical issue that in a conventional liquid crystal display panel, a height difference among color resists in a color filter layer affects rotation of liquid crystal, causes uneven display and further influences display quality.

To solve the above issue, the present invention provides technical solution as follows.

The present invention provides a liquid crystal display panel, comprising: a first underlay substrate comprising a first region and a second region; a photoresist layer disposed on the first underlay substrate; a second underlay substrate; and a liquid crystal layer sandwiched between the first underlay substrate and the second underlay substrate; wherein a top surface of the first region is lower than a top surface of the second region, the photoresist layer comprises a plurality of photoresists disposed on the first region or the second region, and surfaces of sides of the photoresists away from the first underlay substrate are flush with one another; wherein the photoresist layer comprises a first color resist, a second color resist, and a third color resist disposed on the first region and the second region, and a surface of the first color resist away from the first underlay substrate, a surface of the second color resist away from the first underlay substrate, and a surface of the third color resist away from the first underlay substrate are flush with one another.

In at least one embodiment of the present invention, the first underlay substrate comprises a gate insulation layer, the gate insulation layer comprises a first sub-surface and a second sub-surface that are disposed on a same side thereof and located near the photoresist layer, the first sub-surface corresponds to the first region, and the second sub-surface corresponds to the second region.

In at least one embodiment of the present invention, the first sub-surface is lower than the second sub-surface.

In at least one embodiment of the present invention, at least one of the first color resist, the second color resist, and the third color resist is disposed on the first sub-surface.

In at least one embodiment of the present invention, a height difference of the first sub-surface and the second sub-surface is equal to a thickness difference of the first, second, and third color resists with different thicknesses in the photoresist layer.

The present invention further provides a liquid crystal display panel, comprising: a first underlay substrate comprising a first region and a second region; and a photoresist layer disposed on the first underlay substrate; wherein a top surface of the first region is lower than a top surface of the second region, the photoresist layer comprises a plurality of photoresists disposed on the first region or the second region, and surfaces of sides of the photoresists away from the first underlay substrate are flush with one another.

In at least one embodiment of the present invention, the photoresist layer comprises a first color resist, a second color resist, and a third color resist disposed on the first region and the second region, and a surface of the first color resist away from the first underlay substrate, a surface of the second color resist away from the first underlay substrate, and a surface of the third color resist away from the first underlay substrate are flush with one another.

In at least one embodiment of the present invention, the first underlay substrate comprises a gate insulation layer, the gate insulation layer comprises a first sub-surface and a second sub-surface that are disposed on a same side thereof and located near the photoresist layer, the first sub-surface corresponds to the first region, and the second sub-surface corresponds to the second region.

In at least one embodiment of the present invention, the first sub-surface is lower than the second sub-surface.

In at least one embodiment of the present invention, at least one of the first color resist, the second color resist, and the third color resist is disposed on the first sub-surface.

In at least one embodiment of the present invention, a height difference of the first sub-surface and the second sub-surface is equal to a thickness difference of the first, second, and third color resists with different thicknesses in the photoresist layer.

In at least one embodiment of the present invention, the liquid crystal display panel further comprises a pixel electrode and an organic planarization layer, wherein the organic planarization layer is disposed on the photoresist layer, and the pixel electrode is disposed on the organic planarization layer.

In at least one embodiment of the present invention, the photoresist layer comprises a black matrix disposed in the first region, and a surface of a side of the black matrix away from the first underlay substrate is flush with the top surface of the first region.

In at least one embodiment of the present invention, a recess is defined in the first region of the first underlay substrate, and the black matrix is disposed in the recess.

In at least one embodiment of the present invention, a depth of the recess is equal to a thickness of the black matrix.

In at least one embodiment of the present invention, the photoresist layer further comprises a plurality of colored color resists disposed adjacently at intervals, and the black matrix is disposed in the intervals among adjacent two of the colored color resists.

In at least one embodiment of the present invention, the colored color resists are disposed on the second region, and surfaces of sides of the colored color resists away from the first underlay substrate are flush with one another.

Advantages of the present invention are as follows. The present invention, by defining a recess in the underlay substrate, disposes the black matrix in the recess to remove influence of the height of the black matrix to the color resists, or designs step differences in different regions of the COA type underlay substrate according to the height difference among the color resists such that the surfaces of the later manufactured color resists are flush with one another to avoid influence of the height difference of the color resist to rotation of liquid crystal and improve display quality of the liquid crystal.

### DESCRIPTION OF DRAWINGS

To more clearly elaborate on the technical solutions of embodiments of the present invention or prior art, appended figures necessary for describing the embodiments of the present invention or prior art will be briefly introduced as follows. Apparently, the following appended figures are merely some embodiments of the present invention. A person of ordinary skill in the art may acquire other figures according to the appended figures without any creative effort.

FIG. 1 is a schematic plane view of a liquid crystal display panel of an embodiment of the present invention;

FIG. 2 is a schematic cross-sectional structural view according to line A-A in FIG. 1;

FIG. 3 is a schematic cross-sectional structural view according to line B-B in FIG. 1;

FIG. 4 is a schematic cross-sectional view of the liquid crystal display panel of the embodiment of the present invention;

FIG. 5 is a schematic structural view of a photoresist of a first underlay substrate of an embodiment of the present invention;

FIG. 6 is a schematic structural view of an etched gate insulation layer of the embodiment of the present invention;

FIG. 7 is a schematic structural view of a first underlay substrate of the embodiment of the present invention;

FIG. 8 is a schematic structural view of a liquid crystal display panel of another embodiment of the present invention;

FIG. 9 is a schematic structural view of a first underlay substrate of another embodiment of the present invention; and

FIG. 10 is a schematic structural view of a liquid crystal display panel of another embodiment of the present invention.

### DETAILED DESCRIPTION OF PREFERRED EMBODIMENTS

Each of the following embodiments is described with appending figures to illustrate specific embodiments of the present invention that are applicable. The terminologies of direction mentioned in the present invention, such as “upper”, “lower”, “front”, “rear”, “left”, “right”, “inner”, “outer”, “side surface”, etc., only refer to the directions of the appended figures. Therefore, the terminologies of direction are used for explanation and comprehension of the present invention, instead of limiting the present invention. In the figures, units with similar structures are marked with the same reference characters.

The present invention aims at a technical issue that in a conventional liquid crystal display panel, a height difference among color resists in a color filter layer affects rotation of liquid crystal, causes uneven display and further influences display quality. An embodiment of the present invention can solve the defect.

The present invention provides a liquid crystal display panel comprising a first underlay substrate and a photoresist layer disposed on the first underlay substrate. The first underlay substrate comprises a first region and a second region, and a top surface of the first region is lower than a top surface of the second region. The photoresist layer comprises a plurality of photoresists. The photoresists are disposed in the first region or the second region, and surfaces of sides of the photoresists away from the first underlay substrate are flush with one another.

In the prior art, both manufacturing a color filter layer on a glass substrate directly and integrating the color filter layer on an array substrate has the height difference of color resists. To mitigate the height difference among the color resists. The present invention designs the first underlay substrate to have the first region and the second region with different heights such that surfaces of color resists later formed on the first underlay substrate are flush with one another. An embodiment of the present invention describes underlay substrate in different types.

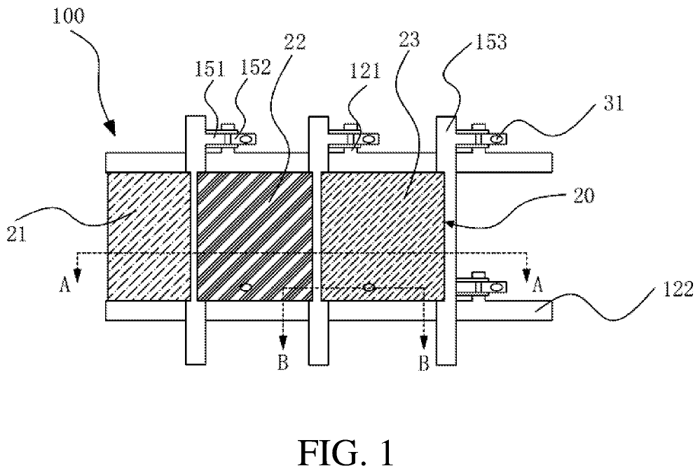

With reference to FIGS. 1 to 3, an embodiment of the present provides a liquid crystal display panel 100 comprising a first underlay substrate 10 and a photoresist layer 20. The photoresist layer 20 is disposed on the first underlay substrate 10.

The first underlay substrate 10 comprises a first region 101 and a second region 102, and a top surface of the first region 101 is lower than a top surface of the second region 102.

The photoresist layer 20 comprises a plurality of photoresists, and the photoresists are disposed in the first region 101 or the second region 102, surfaces of sides of the photoresists away from the first underlay substrate 10 are flush with one another. Specifically, the photoresist layer 20 is a color filter layer, and the photoresist layer 20 comprises a first color resist 21, second a color resist 22, and a third color resist 23. A surface 211 (a top surface of the first color resist 21) of the first color resist 21 away from the first underlay substrate 10, a surface 221 (a top surface of the second color resist 22) of the second color resist 22 away from the first underlay substrate 10, and a surface 231 (a top surface of third color resist 23) of the third color resist 23 away from the first underlay substrate 10 are flush with one another.

Because of different standards of products, different color resist materials have different designed thicknesses. Therefore, disposing different color resists on a same level of a base inevitably causes step difference among color resists. Thus, the color resist with a greater thickness can be disposed on the first region 101 with a lower surface to guarantee that later disposed color resists have same heights. A height difference among the color resist should be the same as a height difference between the first region 101 and the second region 102 of the first underlay substrate 10. It should be understood that when color resists with three different heights exists, the first underlay substrate 10 accordingly has surfaces with three different levels.

Specifically, the first underlay substrate 10 comprises a glass substrate 11 and a gate insulation layer 13 disposed on the glass substrate. The gate insulation layer 13 comprises a first sub-surface 131 and a second sub-surface 132. The first sub-surface 131 and the second sub-surface 132 are disposed on a same side away from the glass substrate 11. The first sub-surface 131 is lower than the second sub-surface 132 (taking an upper surface or a lower surface of the glass substrate 11 as a basis surface). The first sub-surface 131 corresponds to the first region 101, and the second sub-surface 132 corresponds to the second region 102.

It should be understood that during manufacturing the gate insulation layer 13, an insulative material can be deposited for a later etching process to form a recess in a place corresponding to the first region 101 such that the first sub-surface 131 is lower than the second sub-surface 132.

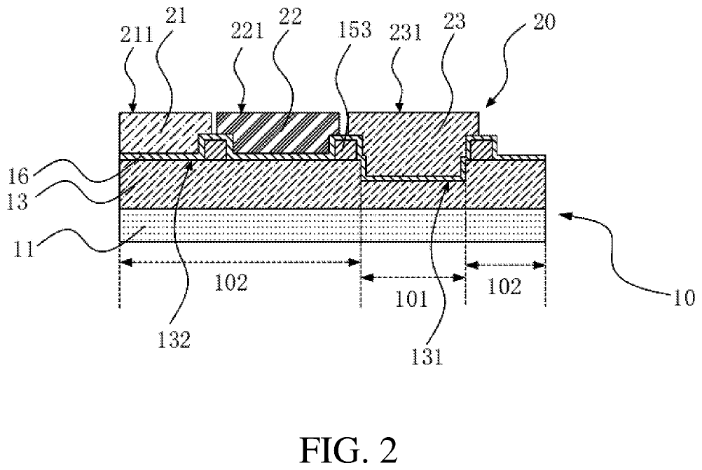

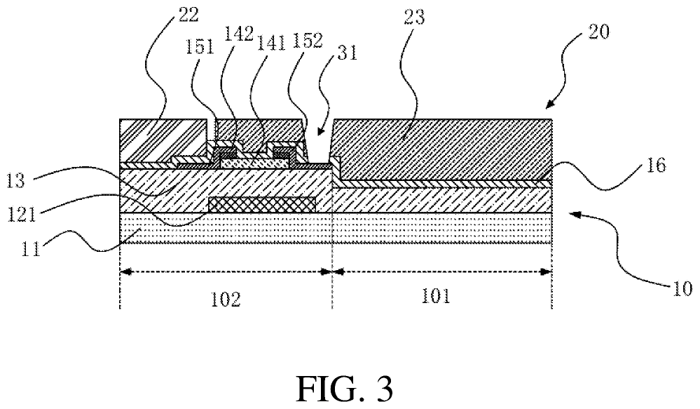

FIGS. 2 and 3 are only illustrative explanations by using color resists with two different thicknesses, the third color resist 23 is disposed on the first sub-surface 131, and the first color resist 21 and the second color resist 22 are disposed on the second sub-surface 132. The first color resist 21 is a blue color resist, the second color resist 22 is a red color resist, and the third color resist 23 is a green color resist. In another embodiment, each of the first color resist 21, the second color resist 22, and the third color resist is one of red, green, and blue.

With reference to FIG. 3, the first underlay substrate 10 further comprises gate electrodes 121, scan lines 122, an amorphous silicon layer 141, a N-type doped amorphous silicon layer 142, source electrodes 151, drain electrodes 152, and data lines 153 that are sequentially on the glass substrate 11.

The gate electrodes 121 is disposed on the glass substrate 11. The gate insulation layer 13 covers the gate electrodes 121. the amorphous silicon layer 141 is disposed on the gate insulation layer 13 and corresponds to the gate electrodes 121. The N-type doped amorphous silicon layer 142 is disposed above two ends of the amorphous silicon layer 141 and exposes a rear channel. The source electrodes 151 and the drain electrodes 152 are disposed on the N-type doped amorphous silicon layer 142, and respectively contact portions of the N-type doped amorphous silicon layer 142 respectively on two sides of the amorphous silicon layer 141.

the source electrodes 151, a passivation layer 16 is disposed on the drain electrodes 152 and the gate insulation layer 13, and the passivation layer 16 is configured to protect a metal device thereunder.

The first color resist 21, the second color resist 22, and the third color resist 23 are disposed on the passivation layer 16.

The scan lines 122 intersect the data lines 153 to define a pixel region, and a main body portion of the color resists of the photoresist layer 20 is located in the pixel region. The scan lines 122 and the gate electrodes 121 are disposed in a same layer and are connected to the gate electrodes 121. The data lines 153, the source electrodes 151, and the drain electrodes 152 are disposed in a same layer and are connected to the source electrodes 151.

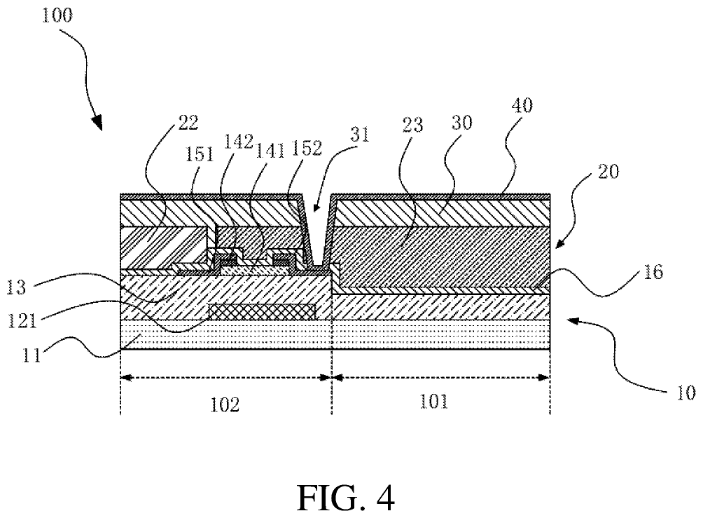

With reference to FIG. 4, the liquid crystal display panel 100 further comprises a pixel electrode 40 and an organic planarization layer 30, the organic planarization layer 30 is disposed on the photoresist layer 20, and the pixel electrode 40 is disposed on the organic planarization layer 30.

A via hole 31 is defined in the liquid crystal display panel 100. The pixel electrode 40 is connected to the drain electrodes 152 through the via hole 31. The via hole 31 is defined through the organic planarization layer 30, the color resist (third color resist 23) corresponding to the photoresist layer 20, and passivation layer 16 from top to bottom.

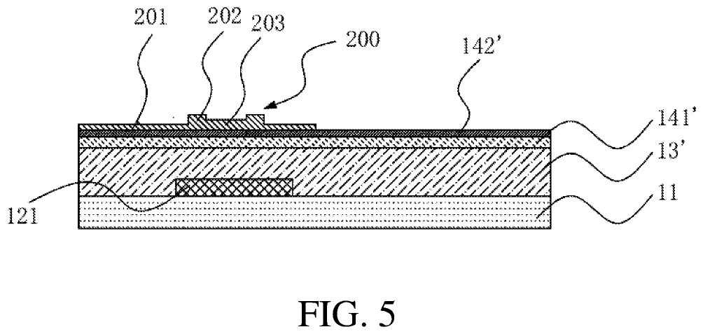

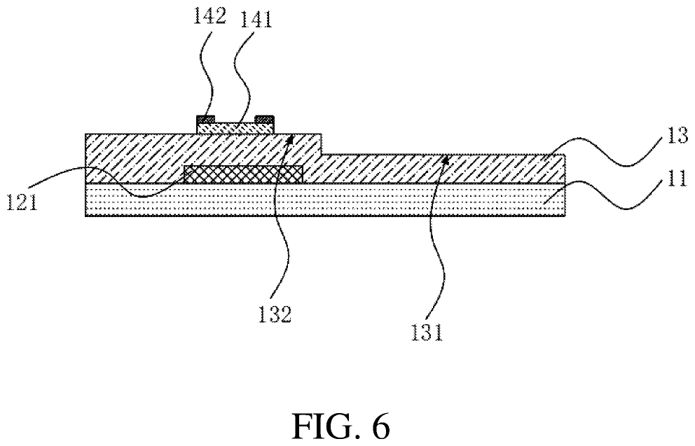

With reference to FIGS. 5 to 7, a manufacturing method for the liquid crystal display panel 100 of an embodiment of the present invention is described as follows.

First, by a physical vapor deposition process, a metal layer is deposited on the glass substrate 11, and patterned gate electrodes 121 and scan lines 122 are formed by lithography process.

Second, by a chemical vapor deposition process, a gate insulation layer material film layer 13′, an amorphous silicon material film layer 141′, and a N-type doped amorphous silicon material film layer 142′ are deposited sequentially on an entire surface of the gate electrodes 121, then film layers with different thicknesses are formed by a step difference mask process.

Specifically, a photoresist material is coated on the N-type doped amorphous silicon material film layer 142′. By using a multi-sectional transmittant mask plate, the photoresist material is exposed and developed to form a photoresist 200 with sections of different heights. The photoresist 200 comprises a second section photoresist 202, a third section photoresist 203, and a first section photoresist 201 with sequentially decreased thicknesses. The second section photoresist 202 corresponds to the N-type doped amorphous silicon layer 142, the third section photoresist 203 corresponds to the rear channel of the amorphous silicon layer 141. An entire portion of the photoresist 200 corresponds to the second region 101 of the liquid crystal display panel 100, and a region without the photoresist 200 corresponds to the first region 101 of the liquid crystal display panel 100.

Then, the N-type doped amorphous silicon material film layer 142′, the amorphous silicon material film layer 141′, and the gate insulation layer material film layer 13′ are dry-etched to form the N-type doped amorphous silicon layer 142, the amorphous silicon layer 141, and the gate insulation layer 13 that are patterned. After etching, a height of the first sub-surface 131 of the gate insulation layer 13 is lower than a height of the second sub-surface 132. A depth of an etched portion of the gate insulation layer 13 (i.e., a recess depth formed by etching) is determined by a film thickness of a color resist as required later.

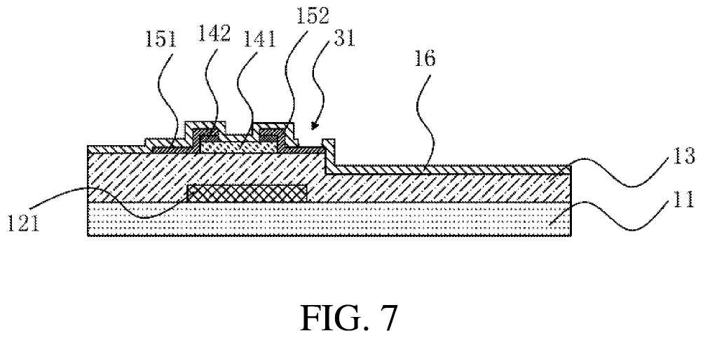

With reference to FIG. 7, by a physical vapor deposition sputtering process, a metal layer is deposited on the N-type doped amorphous silicon layer 142 and the gate insulation layer 13. The patterned source electrodes 151, the drain electrodes 152, and the data lines 153 are formed by a lithography process.

Finally, a passivation layer 16 is formed on the source electrodes 151, the drain electrodes 152, and the gate insulation layer 13 by a chemical vapor deposition process, and a via hole 31 is defined in the passivation layer 16 by a lithography process.

The first color resist 21, the second color resist 22, and the third color resist 23 can be formed on the first underlay substrate 10 formed with the above structures by a yellow light process. Because in the former processes, the gate insulation layer 13 is designed to comprise surfaces with different heights, the color resists of the photoresist layer 20 can be manufactured on the surfaces with different heights such that no height difference exists among the first color resist 21, the second color resist 22, and the third color resist 23 and surfaces of the three color resists are flush with one another.

By a yellow light process, an organic planarization layer 30 is formed on the photoresist layer 20, and then a pixel electrode 40 is formed on the organic planarization layer 30 by a lithography process.

The liquid crystal display panel 100 further comprises a liquid crystal layer and a second underlay substrate. The liquid crystal layer is sandwiched between the second underlay substrate and the first underlay substrate 10. A black matrix is disposed on a side of the second underlay substrate facing the first underlay substrate 10, and a common electrode is disposed on the black matrix. The liquid crystal layer is disposed between the common electrode and the pixel electrode 40.

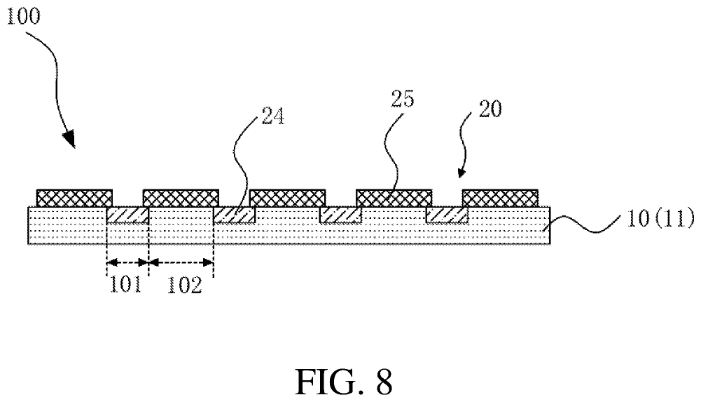

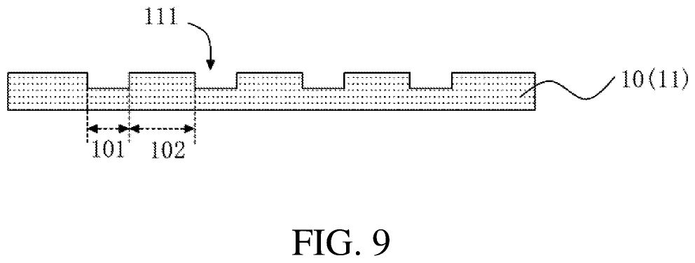

With reference to FIGS. 8 and 9, in other embodiment, the first underlay substrate 10 is a glass substrate 11. The photoresist layer 20 comprises a black matrix 24 and a plurality of colored color resists 25. The black matrix 24 and the colored color resists 25 are disposed on the first underlay substrate 10.

The black matrix 24 is disposed in the first region 101, a surface of a side of the black matrix 24 away from the first underlay substrate 10 is flush with a top surface of the second region 102.

A main body portion of the colored color resists 25 is disposed in the second region 102, surfaces of sides of the colored color resists 25 away from the first underlay substrate 10 are flush with one another.

In a conventional manufacturing process for a color filter substrate, because a black matrix 24 on the glass substrate 11 has a certain height, manufacturing a color filter layer on the glass substrate 11 causes different fluidities of color resists in different regions such that horn-like step differences or bowl-like color resists are formed in an overlapping region of the color resists. Thus, thicknesses of the color resists are different, uneven display occurs when light of a backlight passes through the color filter. An embodiment of the present aims at the issue of the existing step difference among color resists and removes influence of the black matrix 24 to the thicknesses of the color resists.

The first regions 101 and the second regions 102 are plural and are arranged alternately, in other words, one first region 101 is disposed between adjacent two of the second regions 102. A recess 111 is defined in each first region 101, and the black matrix is embedded in the recesses.

A depth of the recess 111 is equal to a thickness of the black matrix 24 such that the black matrix 24 and the first underlay substrate 10 are kept in a same level. Later, when the colored color resists 25 is manufactured on the second region 102, a height of the black matrix 24 would not influence fluidity of the colored color resists 25 such that a step difference of the colored color resists 25 is removed to improve display quality.

Specifically, a patterned photoresist is formed on portions of the glass substrate 11 corresponding to the second regions 102 by a yellow light process, and then, then the glass substrate 11 is processed by a wet-etching process to define the recesses 111 respectively in the first regions 101. Finally the photoresist is peered off to form the patterned first underlay substrate 10.

Black photoresists are formed in the recesses 111 by a yellow light process, then the colored color resists 25 are formed on the first underlay substrate 10 by a yellow light process, each of the colored color resists 25 are one of a red color resist, a green color resist, and a blue color resist. The red color resists, the green color resists, and the blue color resists are adjacently arranged on the first underlay substrate 10, and are spaced apart by the black photoresists. The black photoresists are the black matrix 24 configured to shield pixels from leaking light to prevent color mixing phenomenon among adjacent color resists to further improve contrast of the liquid crystal display panel 100.

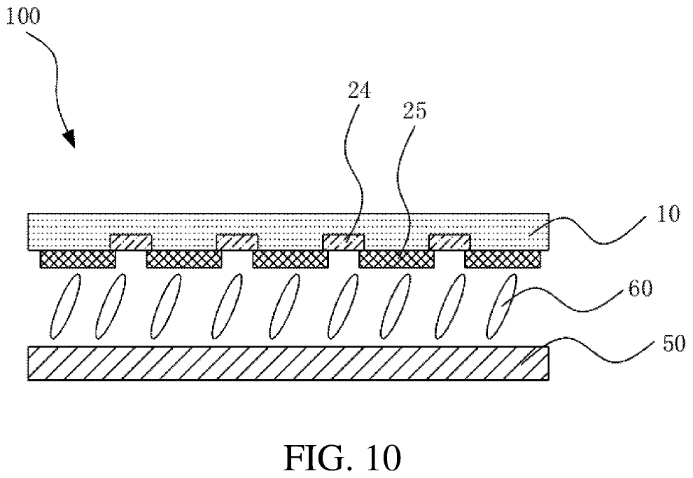

With reference to FIG. 10, the liquid crystal display panel 100 further comprises a second underlay substrate 50 and a liquid crystal layer 60. The liquid crystal layer 60 is sandwiched between the second underlay substrate 50 and the first underlay substrate 10. The second underlay substrate 50 is a thin film transistor array substrate, the black matrix 24 and the colored color resists 25 are disposed on a side of the first underlay substrate 10 facing the second underlay substrate 50. A common electrode (not shown in the figures) is disposed on the first underlay substrate 10 facing the second underlay substrate 50. A structure of the second underlay substrate 50 can refer to a conventional thin film transistor array structure and will not be described repeatedly herein.

Advantages of the present invention are as follows. The present invention, by defining a recess in the underlay substrate, disposes the black matrix in the recess to remove influence of the height of the black matrix to the color resists, or designs step differences in different regions of the COA type underlay substrate according to the height difference among the color resists such that the surfaces of the later manufactured color resists are flush with one another to avoid influence of the height difference of the color resist to rotation of liquid crystal and improve display quality of the liquid crystal.

Although the preferred embodiments of the present invention have been disclosed as above, the aforementioned preferred embodiments are not used to limit the present invention. The person of ordinary skill in the art may make various changes and modifications without departing from the spirit and scope of the present invention. Therefore, the scope of protection of the present invention is defined by the scope of the claims.

1. A liquid crystal display panel, comprising:
a first underlay substrate comprising a first region and a second region;
a photoresist layer disposed on the first underlay substrate;
a second underlay substrate; and
a liquid crystal layer sandwiched between the first underlay substrate and the second underlay substrate;
wherein a top surface of the first region is lower than a top surface of the second region to define a recess in the first region of the first underlay substrate, the black matrix is disposed in the recess, the photoresist layer comprises a plurality of photoresists disposed on or the first region or the second region, and surfaces of sides of the photoresists away from the first underlay substrate are flush with one another;
wherein the photoresist layer comprises a first color resist, a second color resist, and a third color resist disposed on the first region and the second region, and a surface of the first color resist away from the first underlay substrate, a surface of the second color resist away from the first underlay substrate, and a surface of the third color resist away from the first underlay substrate are flush with one another.

2. The liquid crystal display panel as claimed in claim 1, wherein the first underlay substrate comprises a gate insulation layer, the gate insulation layer comprises a first sub-surface and a second sub-surface that are disposed on a same side thereof and located near the photoresist layer, the first sub-surface corresponds to the first region, and the second sub-surface corresponds to the second region.

3. The liquid crystal display panel as claimed in claim 2, wherein the first sub-surface is lower than the second sub-surface.

4. The liquid crystal display panel as claimed in claim 3, wherein at least one of the first color resist, the second color resist, and the third color resist is disposed on the first sub-surface.

5. The liquid crystal display panel as claimed in claim 3, wherein a height difference of the first sub-surface and the second sub-surface is equal to a thickness difference of the first, second, and third color resists with different thicknesses in the photoresist layer.

6. A liquid crystal display panel, comprising:
a first underlay substrate comprising a first region and a second region; and
a photoresist layer disposed on the first underlay substrate;
wherein a top surface of the first region is lower than a top surface of the second region to define a recess in the first region of the first underlay substrate, the black matrix is disposed in the recess, the photoresist layer comprises a plurality of photoresists disposed on the first region or the second region, and surfaces of sides of the photoresists away from the first underlay substrate are flush with one another.

7. The liquid crystal display panel as claimed in claim 6, wherein the photoresist layer comprises a first color resist, a second color resist, and a third color resist disposed on the first region and the second region, and a surface of the first color resist away from the first underlay substrate, a surface of the second color resist away from the first underlay substrate, and a surface of the third color resist away from the first underlay substrate are flush with one another.

8. The liquid crystal display panel as claimed in claim 7, wherein the first underlay substrate comprises a gate insulation layer, the gate insulation layer comprises a first sub-surface and a second sub-surface that are disposed on a same side thereof and located near the photoresist layer, the first sub-surface corresponds to the first region, and the second sub-surface corresponds to the second region.

9. The liquid crystal display panel as claimed in claim 8, wherein the first sub-surface is lower than the second sub-surface.

10. The liquid crystal display panel as claimed in claim 9, wherein at least one of the first color resist, the second color resist, and the third color resist is disposed on the first sub-surface.

11. The liquid crystal display panel as claimed in claim 9, wherein a height difference of the first sub-surface and the second sub-surface is equal to a thickness difference of the first, second, and third color resists with different thicknesses in the photoresist layer.

12. The liquid crystal display panel as claimed in claim 6, comprising a pixel electrode and an organic planarization layer, wherein the organic planarization layer is disposed on the photoresist layer, and the pixel electrode is disposed on the organic planarization layer.

13. The liquid crystal display panel as claimed in claim 6, wherein the photoresist layer comprises a black matrix disposed in the first region, and a surface of a side of the black matrix away from the first underlay substrate is flush with the top surface of the first region.

14. (canceled)

15. The liquid crystal display panel as claimed in claim 6, wherein a depth of the recess is equal to a thickness of the black matrix.

16. The liquid crystal display panel as claimed in claim 13, wherein the photoresist layer further comprises a plurality of colored color resists disposed adjacently at intervals, and the black matrix is disposed in the intervals among adjacent two of the colored color resists.

17. The liquid crystal display panel as claimed in claim 16, wherein the colored color resists are disposed on the second region, and surfaces of sides of the colored color resists away from the first underlay substrate are flush with one another.
